(19) United States
(12) Patent Application Publication
(10) Pub. No.: US 2018/0283673 A1
(43) Pub. Date: Oct. 4, 2018

(54) LED LIGHTING MODULE, SYSTEM, AND METHOD

(71) Applicant: Hai Hua Wu, Temple City, CA (US)

(72) Inventor: Hai Hua Wu, Temple City, CA (US)

(21) Appl. No.: 15/727,190

(22) Filed: Oct. 6, 2017

Related U.S. Application Data
(63) Continuation of application No. 14/729,067, filed on Jun. 3, 2015, now abandoned.

(51) Int. Cl. F21V 29/56; F21V 29/51; F21Y 107/30; F21Y 115/10

(52) U.S. Cl. CPC F21V 29/56; F21Y 2115/10; F21Y 2107/30; F21V 29/51

(57) ABSTRACT

A light-emitting diode (“LED”) lighting module comprising a core having a cavity for enhancing the cooling capabilities of the LED lighting module. Wherein cooling via the cavity may be accomplished by active cooling, and/or passive cooling. The LED lighting module further boasts retrofitting capabilities applicable in retail, commercial and household units.

### CROSS-REFERENCE TO RELATED APPLICATION

This application is a continuation of copending U.S. application Ser. No. 14/729,067, entitled LED Lighting Module, System, and Method, filed Jun. 3, 2015 in the United States Patent and Trademark Office, the contents of which are incorporated by reference herein as if set forth in their entirety.

### FIELD OF THE INVENTION

The present invention relates generally to a light-emitting diode (“LED”) lighting modules, systems, and methods with retrofit capability. Specifically, the present invention discloses a LED lighting fixture comprising a heat dissipation component. Furthermore, the inventive LED lighting fixture comprises retrofitting capabilities integrated into the heat dissipation component.

### BACKGROUND ART

Conventional lighting was carried out by bulbs that used a heated filament encapsulated by an outer casing. The entrapped filament is filled with a gas that prevented the filament from burning up, and protected the filament from foreign items.

In recent times, the traditional filament lighting fixture has been replaced by much more efficient and longer lasting lighting elements, such as LED lighting fixtures. An LED generally includes a diode mounted onto a die or chip. The diode is then surrounded by an encapsulated for protecting the diode. The die receives electrical power from a power source and supplies power to the diode.

However, retrofitting of these LED lighting fixtures upon traditional filament lighting fixtures isn't quite as easy as it would seem. As LED lighting fixtures have wholly different needs and characteristics as compared with previous bulbs, adaptation and modification of the LED lighting fixture is required.

Specifically, the greatest problem between LED lighting fixtures and conventional filament lighting fixtures happens to be the dissipation of heat.

Although various methods have been disclosed, such as heat transfer paths, and heat sinks, and active cooling. The problem still remains, and is especially relevant in high power LED lighting fixtures. The conventional heat dissipation systems (i.e. radiating a large percentage of heat to a front lens of a lamp) do not adequately reduce heat in higher power LED systems. Consequently, high power LED systems tend to run at high operating temperatures. High operating temperatures degrade the performance of the LED lighting systems. Empirical data has shown that LED lighting systems may have lifetimes approaching 50,000 hours while at room temperature; however, operation at close to 90° C. reduces LED life to less than 7,000 hours.

The present invention recognized and addresses the fact that LED lighting fixtures have wholly different needs and characteristics as compared with previous bulbs that used a filament. And specifically discloses modules, systems and methods for effectively and efficiently dissipating heat from LED lighting fixtures.

### SUMMARY OF THE INVENTION

Various embodiments of the present invention will undoubtedly find utility in society. For example, in one embodiment the present invention teaches a LED lighting fixture comprising a cavity extending at least partially through about the center of the LED sighting fixture, wherein the cavity allows for dissipation of heat.

In various embodiments, the dissipation of heat through the cavity may be configured to be passive, active, or a combination of both. By way of example, active dissipation of heat may be facilitated by channeling cooling lines through the cavity, channeling liquid through the cavity, allowing for condensation/evaporation of a coolant through the cavity, as well as other similar cooling methods know in the art.

In yet another embodiment, the dissipation of heat away from the LED lighting module may be accomplished by a passive mechanism, namely, an adequate amount of heat dissipation material attached to the LED.

For a better understanding of the structure of the LED lighting module, system, and method, and its functions, detailed explanations are given below with reference to the attached drawings. The LED lighting fixture is not limited, however, to the particular arrangement and/or configurations portrayed in the subject drawing figures.

### BRIEF DESCRIPTION OF THE DRAWINGS

These and other features of this invention will be more readily understood from the following detailed description of the various aspects of the invention taken in conjunction with the accompanying drawings in which:

FIG. 1 provides a perspective view of an LED lighting fixture in accordance with an embodiment or portion of an embodiment of the present invention.

FIG. 2 provides a perspective view of an LED lighting fixture and active cooling system in accordance with an embodiment or portion of an embodiment of the present invention.

FIG. 3 depicts a perspective view of no LED lighting fixture and passive cooling system in accordance with an embodiment or portion of an embodiment of the present invention.

FIG. 4 depicts a front view of an LED lighting fixture and passive cooling system in accordance with an embodiment or portion of an embodiment of the present invention.

FIG. 5 depicts a side view of an LED lighting fixture and passive cooling system in accordance with an embodiment or portion of an embodiment of the present invention.

FIG. 6 provides a perspective view of an LED lighting fixture and passive cooling system in accordance with an embodiment or portion of an embodiment of the present invention.

FIG. 7 depicts a top view of an LED lighting fixture and passive cooling system in accordance with an embodiment or portion of an embodiment of the present invention.

FIG. 8 depicts a side view of an LED lighting fixture and passive cooling system in accordance with an embodiment or portion of an embodiment of the present invention.

FIG. 9 depicts a perspective view of an LED lighting fixture and active cooling system in accordance with an embodiment or portion of an embodiment of the present invention.

FIG. 10 depicts a perspective view of an LED lighting fixture and active cooling system in accordance with an embodiment or portion of an embodiment of the present invention.

FIG. 11 displays a perspective view of an LED lighting fixture and both active cooling system and passive cooling system in accordance with an embodiment or portion of an embodiment of the present invention.

FIG. 12 provides a front view of an LED lighting fixture and both active cooling system and passive cooling system in accordance with an embodiment or portion of an embodiment of the present invention.

FIG. 13 depicts a perspective view of an LED lighting fixture in accordance with an embodiment or portion of an embodiment of the present invention.

FIG. 14 depicts a perspective view of an LED lighting fixture in accordance with an embodiment or portion of an embodiment of the present invention.

FIG. 15 depicts a perspective view of an LED lighting fixture in accordance with an embodiment or portion of an embodiment of the present invention.

FIG. 16 provides a perspective cross-sectional view of tubing incorporated in the LED lighting fixture in accordance with an embodiment or portion of an embodiment of the present invention.

FIG. 17 depicts a perspective view of an LED lighting fixture and passive cooling system in accordance with an embodiment or portion of an embodiment of the present invention.

FIG. 18 provides a chart containing the results of heat dissipation incorporating the LED lighting fixture in accordance with an embodiment or portion of an embodiment of the present invention.

FIG. 19 provides a perspective view of an LED lighting fixture and active cooling system in accordance with an embodiment or portion of an embodiment of the present invention.

FIG. 20 provides a partially exploded perspective view of an LED lighting fixture in accordance with an embodiment or portion of an embodiment of the present invention.

The attached drawings are merely schematic representations, not intended to portray specific parameters of the invention. Furthermore, the attached drawings are intended to depict only typical embodiments of the invention, and therefore should not be considered as limiting the scope of the invention. In the attached drawings, like numbering represents like elements.

### DETAILED DESCRIPTION OF THE INVENTION

The present invention discloses a LED lighting module, system and method for use in any and all applications where lighting is required, as well as applications desirous of retrofitting LED lighting. In particular, the present invention teaches a LED lighting fixture configured to allow for more efficient and better cooling of LED lighting. Specifically, the present invention is adaptable for active cooling of LED lights, passive cooling of LED lights, as well as combinations of active and passive cooling of LED lights.

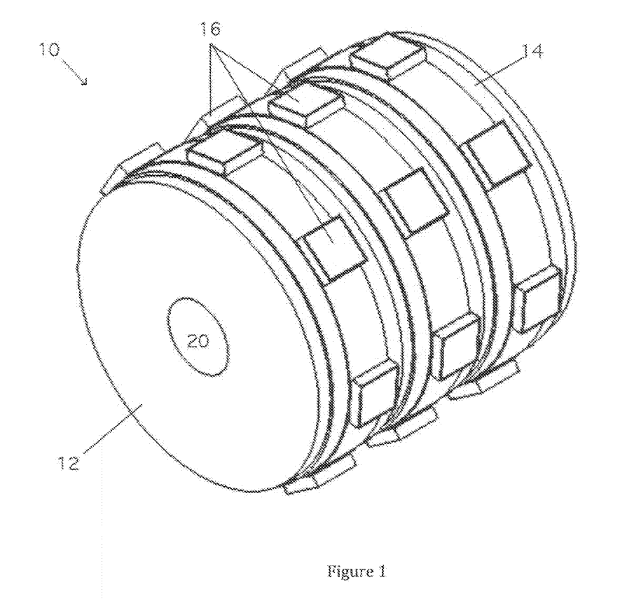

Referring now to the Figures. FIG. 1 provides a perspective view of a LED lighting fixture in accordance with an embodiment or portion of an embodiment of the present invention. FIG. 1 depicts a LED module 10, configured with at least one light emitting member 36. The LED module 10 further comprises a mounting frame 14 affixed to the core 12, wherein the mounting frame 14 has conductive properties for conducting electricity. The core 12 which provides support for the LED module 10, is configured to be at least partially convex in shape in at least one axis. The at least one light emitting member 16 is mounted to the core 12, and is in electronic communication with the mounting frame 14. The light emitting member 16 may comprise a circuit board for electronic communication with the mounting frame 14, or a circuit board may be integrated into the mounting frame 14, for electrical communication with the light emitting member 16. The light emitting member 16 may be a two-lead semiconductor light source, such as a light emitting diode, organic light emitting diodes (OLED), quantum dot LED, phosphor-based LED, combinations therefrom, and derivatives thereof. When a suitable voltage is applied to the leads, electrons are able to recombine with electron holes within the device, releasing energy in the form of photons.

The core 12 is preferably constructed from a non-conductive material, such as ceramic, glass, plastics, plastic composites, resins, impregnated foam, combinations therefrom, and derivatives thereof. The mounting frame 14 is preferably constructed from a conductive material, including metals, alloys, carbon, plastic composites, metallic composites, combinations therefrom, and derivatives thereof.

In an alternative embodiment, the core 12 may be coated with a non-conductive element, establishing a buffer layer between the core 12 and mounting frame 14. In this embodiment, the core 12 may be constructed of any material, however, materials having a higher dissipation factor (“DF”—is a measure of loss-rate of energy of a mode of oscillation in a dissipative system), would provide additional utility to the present invention. In addition, this embodiment would dictate the buffer layer be preferably constructed from a non-conductive material.

The LED module 10 farther comprises a cavity 20 situated in the core 12. The cavity 20 may project through the entire length of the LED module 10, or may only partially project into the core 12 of the LED module 10. As depleted in FIG. 1, the cavity 20 is centered along the circumference of the LED module 10, and extends the entire length of the LED module 10. The shape, width (w), height (h) of the cavity 20 is constricted only by the size of the core 12, such that the cavity 20 does not extend beyond the external width (w) and height (h) of the core 20.

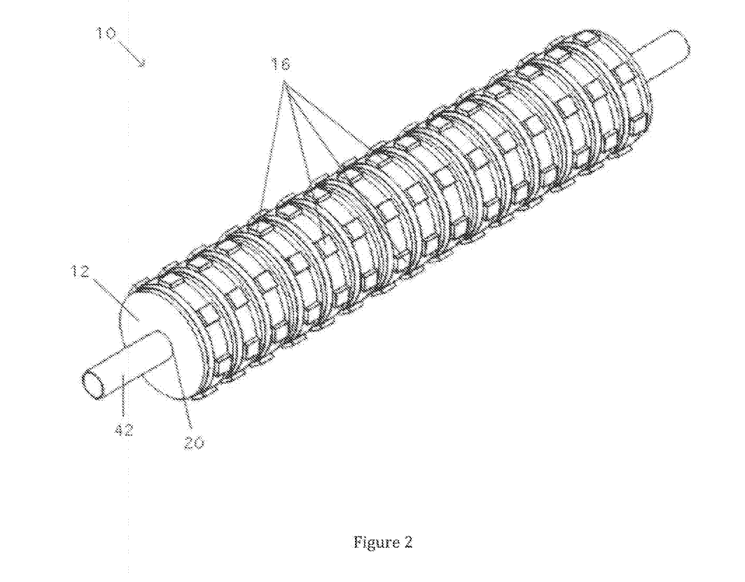

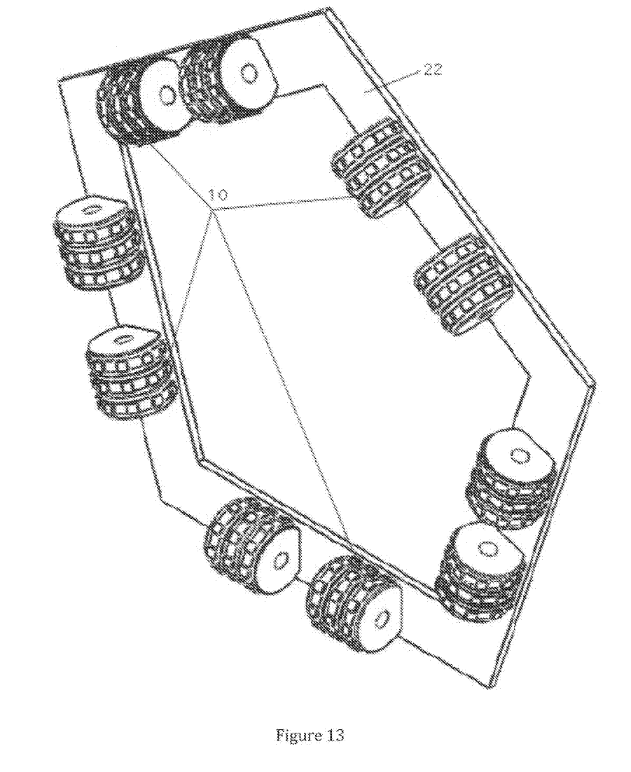

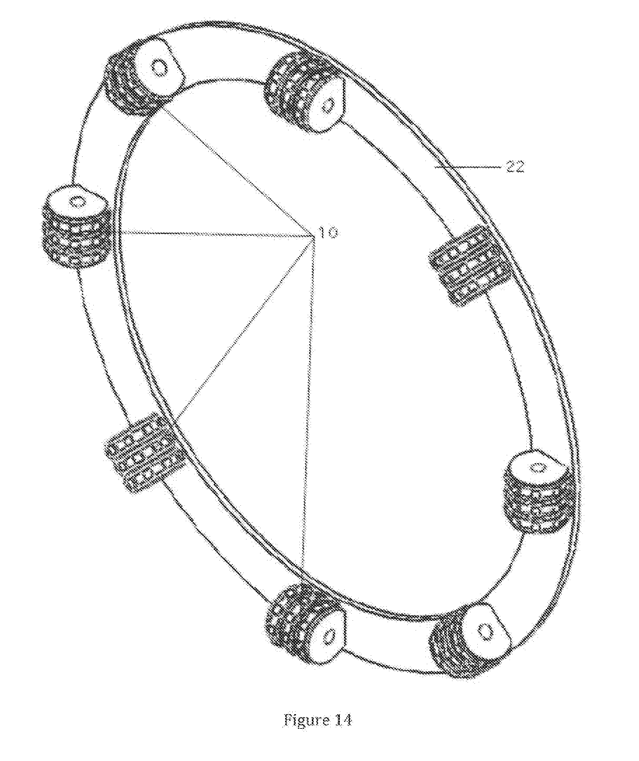

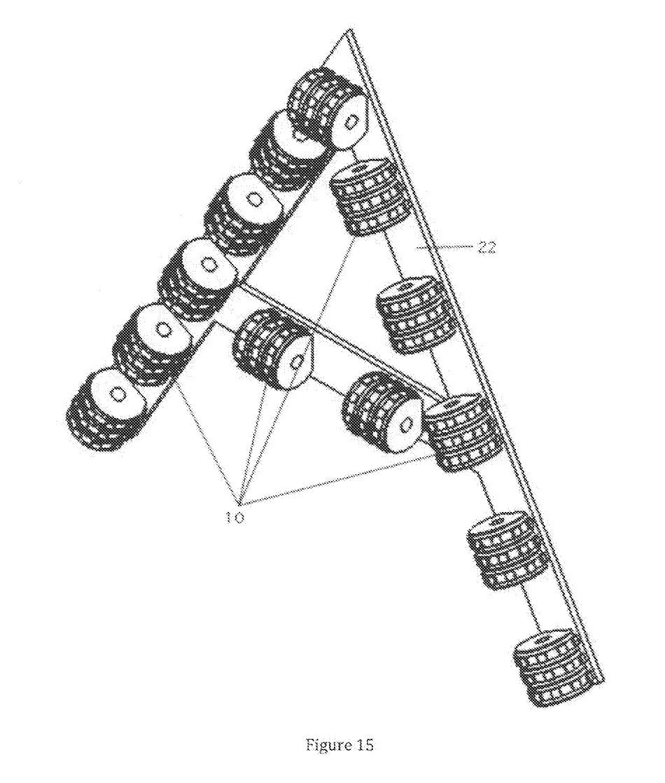

FIG. 2 provides a perspective view of an LED module 10 and active cooling system 24 in accordance with an embodiment or portion of an embodiment of the present invention. Specifically, FIG. 2 depicts the modular capabilities of the LED module 10 depicted in FIG. 1. As depicted, multiple LED modules 10 (a, b, c, . . . x) may be configured in conjunction with one another to increase luminosity and the capabilities of the subject LED lighting module, system and method. Although the LED modules 10 (a, b, c . . . x) may be configured on axis, as shown in FIG. 2, one of skill in the art may contemplate numerous configurations of the LED modules 10 to suit specific and varying needs for lighting and/or design factors (See FIGS. 13-15). By way of example, the LSD modules 10 may be configured atop one another, in a circular or oval pattern, and/or at various angles to promote or dissipate hot spots. In further embodiments, the LED modules 10 may also be independently reconfigurable in one of more axes, allowing for variations in lighting.

FIG. 2 further depicts capillary tubing 42, which is a component of the active cooling system 24. The capillary tubing 42 is configured in the cavity 20 for active dissipation of heat from the LED modules 10 using a coolant. A complete disclosure of the active cooling system 24 and associated cooling elements are further disclosed below.

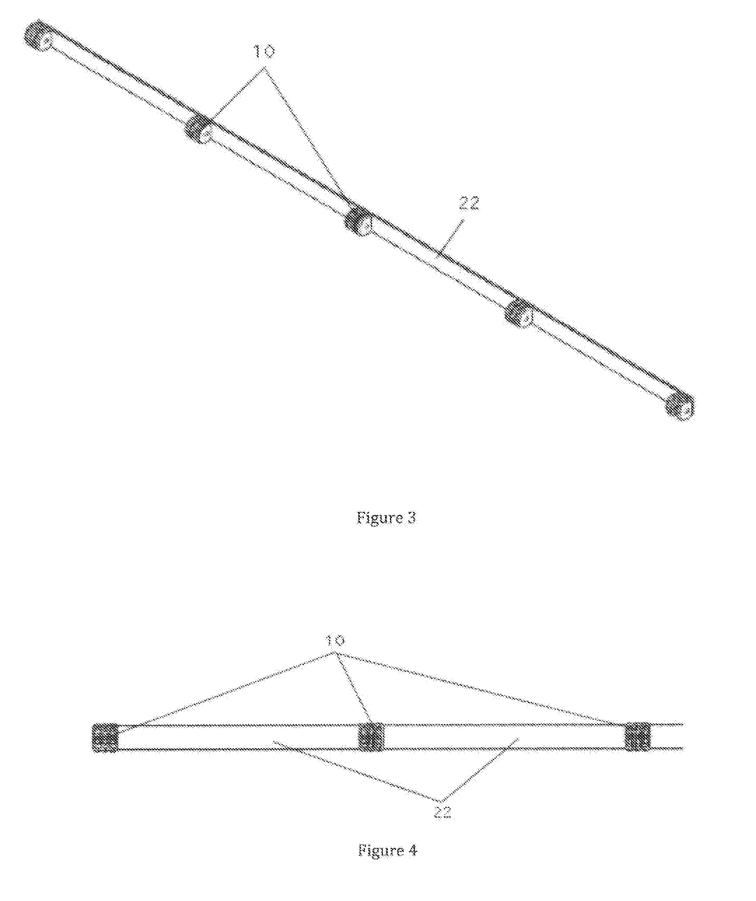

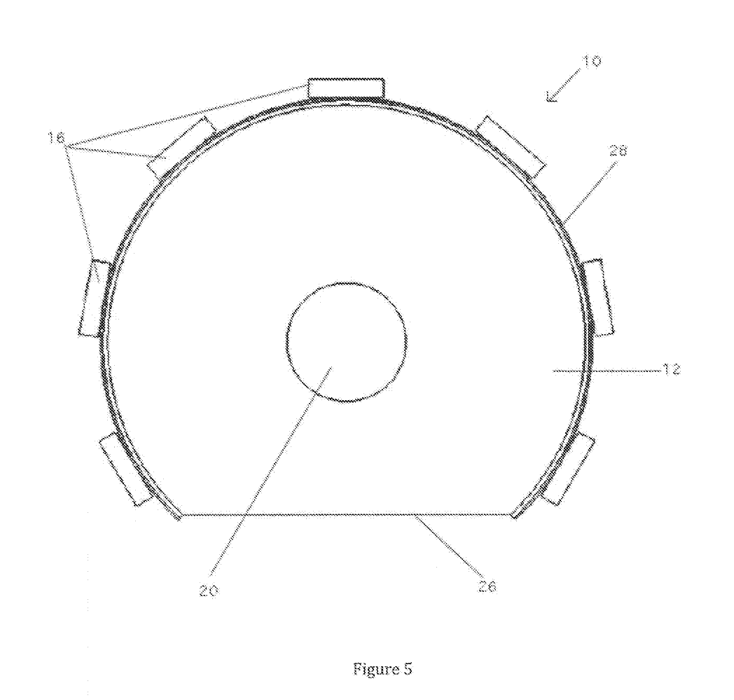

FIG. 3 depicts a perspective view of an LED module 10 and passive cooling system 22 in accordance with an embodiment or portion of an embodiment of the present invention. FIG. 3 depicts the use of multiple LED modules 10 configured a distance from each other, and In communication with each other via a passive tooling system 22. The passive cooling system 22 is configured to provide adequate heat dissipating material to dissipate heat generated by each LED module 10. In addition the passive cooling system 22 is further configured to allow for mounting of the lighting fixture using mounting holes 30. As a unit, the passive cooling system 22 is preferably constructed from one or more materials having a high dissipation factor (“DF”) such as aluminum, copper or gold, to name a few. Furthermore, FIG. 3 (and to greater degree, FIG. 5) depicts an embodiment of the LED module 10 having a list section 26 along the convex surface 28 of the core 12. The flat section 26 is configured to increase surface area in communication with the passive cooling system 22, thus increasing the rate and/or efficiency of dissipation of heat.

In the example provided in FIGS. 3-5, each twenty (20) watt LED module 10 produces approximately 1200 joules of heat per minute. The amount of heat dissipation material needed to adequately reduce the temperature of the LED module 10 to near-optimal performance levels is dependent on specific heat capacity of the heat dissipation material (e.g.—AL 0.904 J/g/C; Iron 0.449 j/g/C), as well the mass and orientation of the heat dissipation material. In the example presented in FIGS. 3-5, the heat dissipation material has a specific heat capacity of approximately 0.9 J/g/C, thus using 0.147 pounds (mass) of material to reduce the temperature of the LED module 10 to near-optimal levels. (For additional heat dissipation details please reference FIG. 17, below)

FIGS. 4 and 5 depict front and side views, respectively, of at least one LED module 10 and passive cooling system 22 in accordance with an embodiment or portion of an embodiment of the present invention. FIG. 4 shows two LED modules 10 mounted to the passive cooling system 22. FIG. 5 details the attachment of the flat section 26 of the LED module 10 to the passive cooling system 22. Further depicted in FIG. 5 are the LEDs 16 attached to the core 12 and/or mounting frame 14.

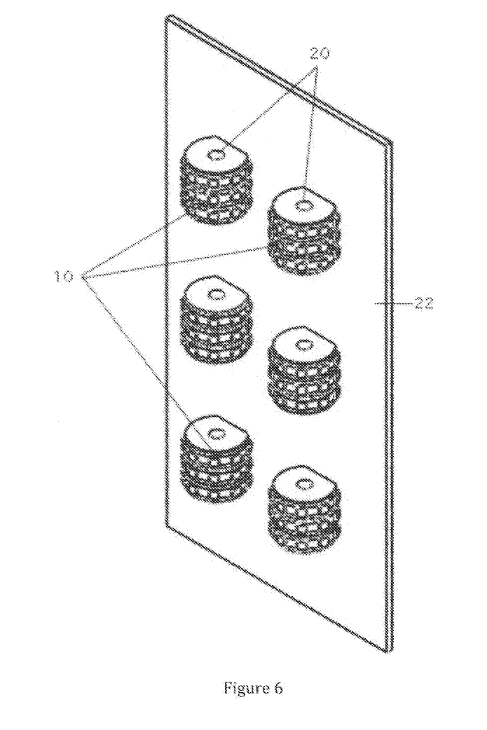

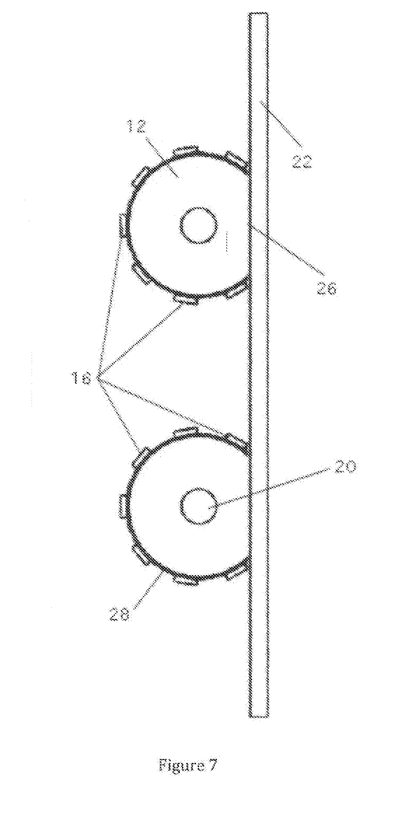

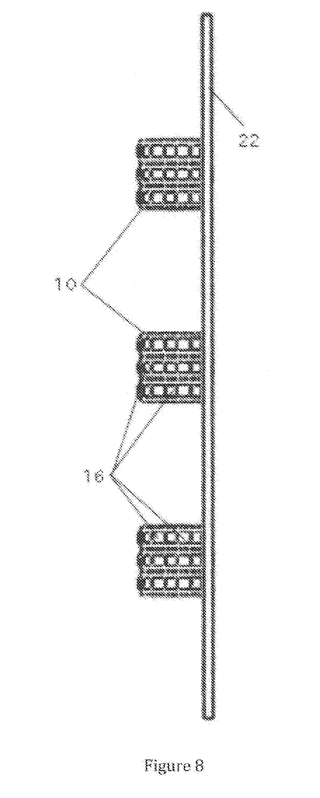

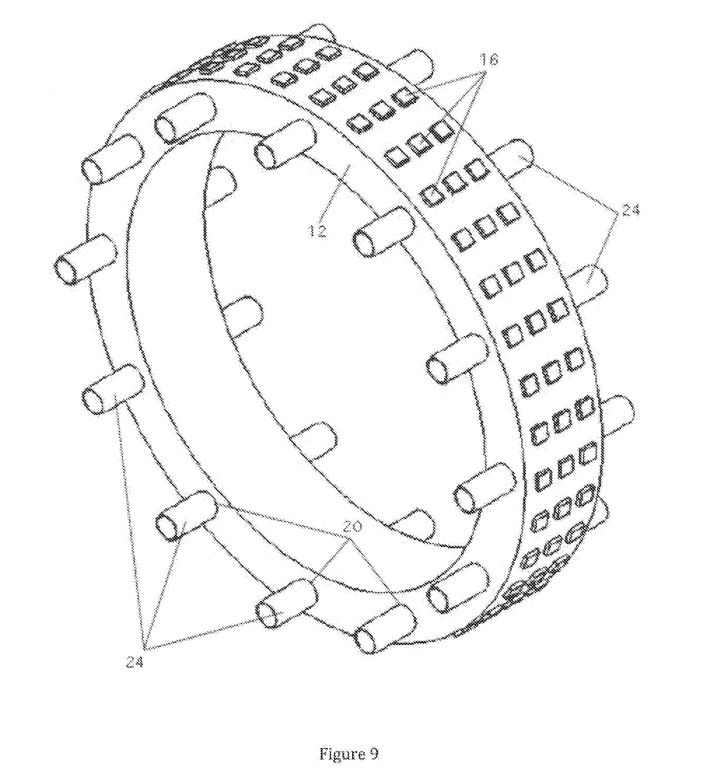

FIG. 6 provides a perspective view of an LED modules 10 and passive cooling system 22 in accordance with an embodiment or portion of an embodiment of the present invention. FIG. 7 depicts a top view of an LED modules 10 and passive cooling system 22 disclosed in FIG. 6. And FIG. 8 depicts a side view of an LED modules 10 and passive cooling system 22 disclosed in FIGS. 6 and 7. Specifically, FIGS. 6, 7 and 8 provide disclosure of LED modules 10 and passive cooling system 22 configured for retrofitting into a standard industrial fluorescent light fixture. The LED modules 10 are spaced a distance from one another and are in electrical communication with one another. The enlarged surface area of the passive cooling system 22 allows for the use of less (thinner) material, while achieving efficient heat dissipation. Similar to the embodiment disclosed in FIGS. 3, 4, and 5, the passive cooling system 22 is further configured to allow for mounting of the lighting unit using mounting holes 30.

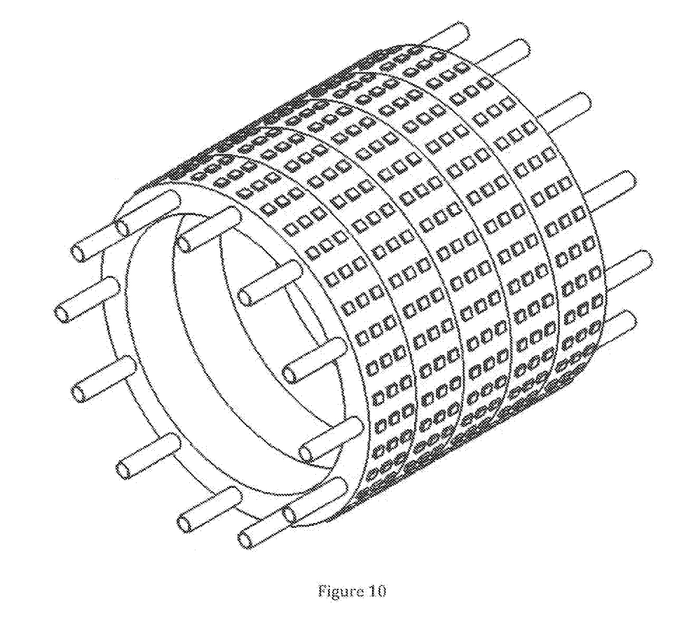

FIGS. 9 and 10 provide perspective views of an LED module 10 and active cooling system 24 in accordance with an embodiment or portion of an embodiment of the present invention. FIGS. 9 and 10 provide additional embodiments of configuring the present invention for application in extremely high luminosity lighting fixtures. FIG. 9 depicts a single row lantern-type fixture configured in a circular arrangement LEDs 16 are mounted to the outer surface of the core 12, with multiple cavities 20 configured throughout the core 12 to allow for greater cooling. Although each cavity 20 in FIG. 9 is depicted to have an active cooling system 24, various iterations comprising of active cooling systems 24 and passive cooling systems 22 are contemplated herein. By way of example, an embodiment of the present invention may include staggered passive cooling systems 22 and active cooling systems 24, configured in the core 12. Additionally, LEDs 16 may be mounted on the interior surface of the core 12 for increased luminosity. Even further, the core 12 may be cylindrical in shape to allow for additional LEDs 16 configured in a circular pattern to provide even light in all three axes.

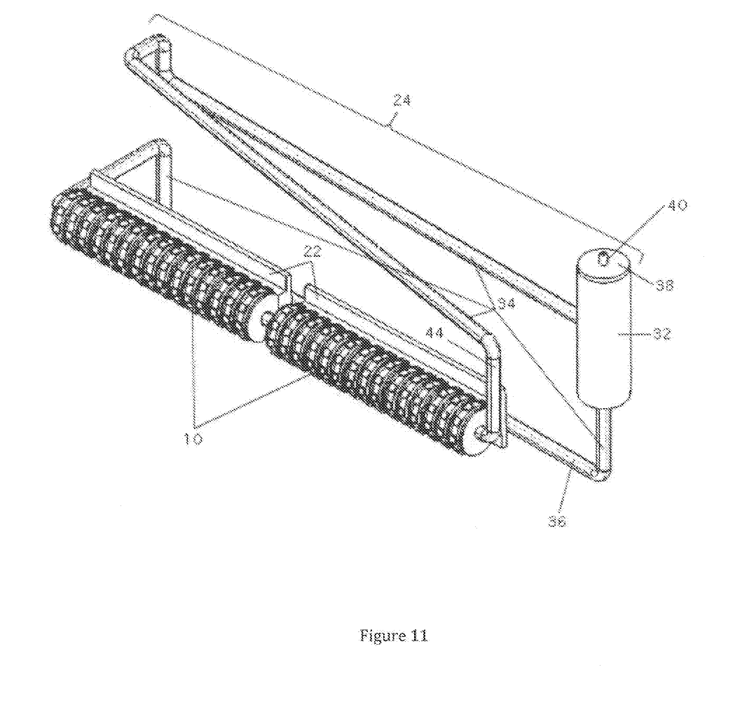

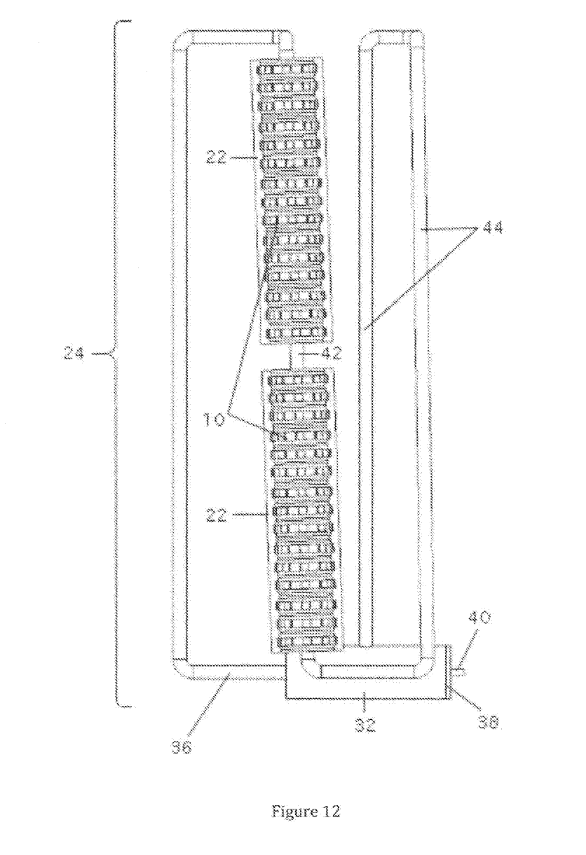

FIGS. 11 and 12 display perspective and front views, respectively, of an LED module 10 comprising an active cooling system 24 in accordance with an embodiment or portion of an embodiment of the present invention. Specifically, FIGS. 11 and 12 disclose the active cooling system 24, and components associated with the active cooling system 24, as well as the interaction between the active cooling system 24 and the LRD modules 10. The active cooling system 24 comprises a network of tubes 34 that passively cycle coolant through the tubes incorporating evaporation and re-condensation for exchanging heat and driving the coolant cycle.

The active cooling system 24 comprises a reservoir 32 containing coolant. This reservoir 32 is situated such that when the reservoir 32 is filled with coolant and sealed, a small amount of pressure is established in the tubes 34. This positive pressure is enough to drive the coolant through the active cooling system 24, and in conjunction with tubing orientation, restricts movement of the coolant to a particular direction.

The coolant leaves the reservoir 32 and travels down and through the inlet tubing 36 to reach the LED modules 10. As stated previously, the pressure generated in the reservoir 32, drives the coolant up the vertical portion of the inlet tubing 36. The reservoir 32 is configured with enough coolant such that the reservoir 32 and the inlet tubing 36 is completely filled with coolant.

The reservoir 32 comprises a caped service port 38 containing a one-way valve 40. The one-way valve 40 allows for pressure to be removed from the system but does not allow pressure to enter. By creating a slight vacuum through the service port 38, negative pressure is created in the active cooling system 24, thus lowering the vapor point of the coolant, and allowing the coolant to become a gas at a lower temperature. This also allows for the coolant to expand since there are no air pockets within the system that are already taking up volume, which in turn allows the coolant to cycle much faster than if the vaporized coolant were to compete for space with any existing air in the system.

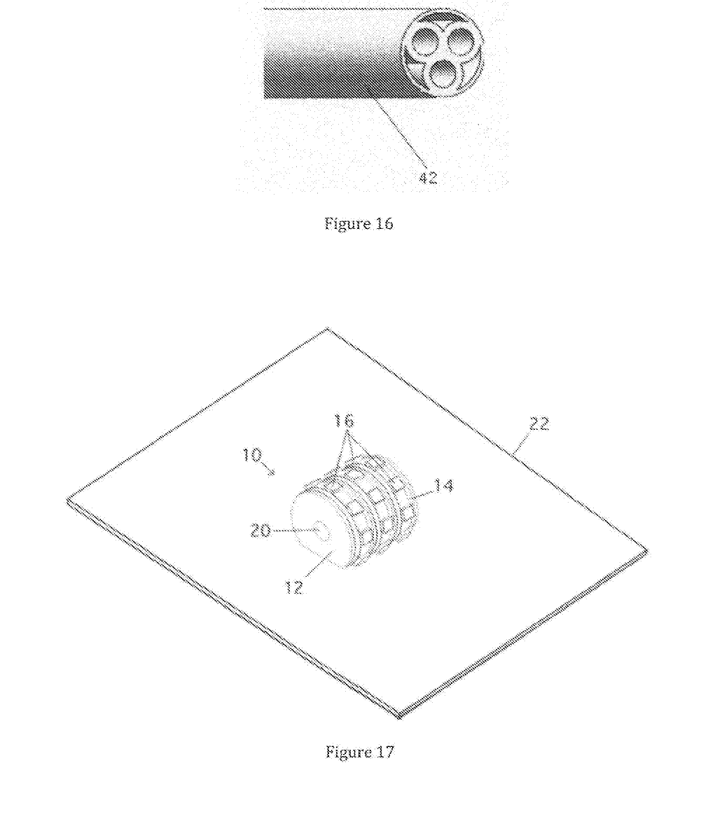

Once the coolant has travelled through the inlet tubing 36 it is ready to enter the LED modules. Passing through the cavity 20 of the LED modules 10 is capillary tubing 42 which allows for the continued flow of coolant through the active cooling system 24. The capillary tubing 42 is attached to the inlet tubing 36 at one end, and further attached to the outlet tubing 44 at the opposing end. The capillary tubing 42 runs through the care 12 and helps facilitate heat exchange with the LED modules 10. The specific function of capillary tubing (in comparison to normal tubing—See FIG. 16) is such that it utilizes a liquid's tendency to create adhesion between the fluid and the solid inner wall and allows a fluid to “climb up” through the capillary tubing 42 in cases where fluid in regular tubing cannot. The relevance of capillary tubing 42 in this section of the system is important because the capillary tubing running through the core 12 of the LED modules 10 is not completely horizontal, but is configured at a small degree upwards. Capillary tubing 42 is required in this sloped orientation because the pressure generated by the reservoir 32 is not great enough to push the fluid up this section. The capillary action allows the coolant to draw itself up from the start of the capillary tubing 42 through to the end of the capillary tubing 42, and expel the coolant into the outlet tubing 44.

When the LED modules 10 are in use, they generate a tremendous amount of heat. Thus heat is conducted by and through the core 12 to the capillary tubes 42. Alter the capillary tubes 42 reach a certain temperature, the coolant evaporates and gas is created. The inherent nature of the gas rises up through the outlet tubing 44 and is cooled back to liquid coolant before being deposited into the reservoir 32. This heat exchange between the LED modules 10 and capillary tubing 42 is what cools down the LEDs. The heat is being drawn away from the LEDs via the core 12 and capillary tubing 42 and thus allows the LED modules 10 to sustain a stable and much lower operating temperature.

This entire process is repeated as the LED modules 10 are being powered and the cycle combination of the reservoir 32, capillary tubing 42, evaporation, condensation, and gravity drives the active cooling system 24 without the need for any external pumping system.

By reference, and incorporated in whole herein, certain principals of the present invention may take advantage of a scientific principal known as Capillary action (sometimes capillarity, capillary motion, or wicking). Identified as the ability of a liquid to flow in narrow spaces without the assistance of, and in opposition to, external forces like gravity. The effect can be seen in the drawing up of liquids between the hairs of a paint-brush, in a thin tube, in porous materials such as paper. In some non-porous materials such as liquefied carbon fiber, or in a cell. Due to intermolecular forces between the liquid and surrounding solid surfaces, the liquid is drawn against external forces. If the diameter of the tube is sufficiently small, then the combination of surface tension (which is caused by cohesion within the liquid) and adhesive forces between the liquid and container act to lift the liquid, in short, the capillary action is due to the pressure of cohesion and adhesion which cause the liquid to work against gravity.

An exemplary coolant for the above referenced inventive active cooling system 24 may be composed of about 50% to 85% denatured alcohol and about 15% to 50% antifreeze. Additional coolants may be derived from ethanol and distilled water, derivatives therefrom and combinations thereof.

FIGS. 13, 14 and 15 are images that provide perspective views of LED modules in accordance with an embodiment or portion of an embodiment of the present invention. Specifically, FIGS. 13, 14 and 15 provide various designs which may be configured incorporating the inventive LED module, system and method described herein.

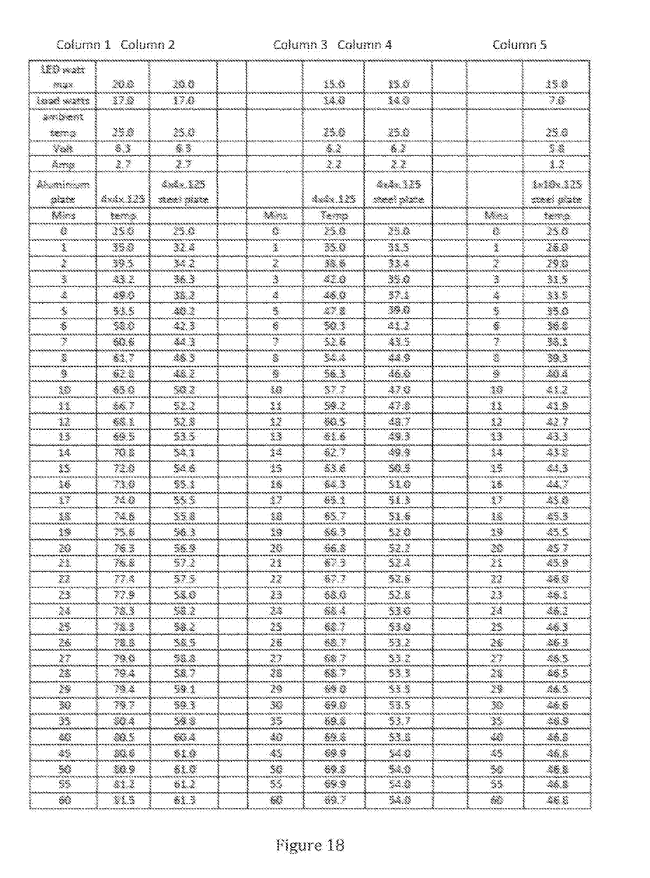

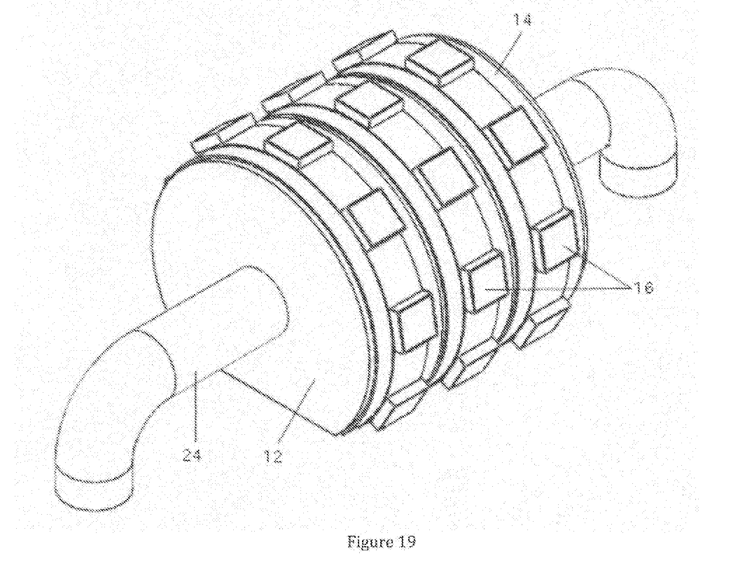

FIG. 17 depicts a perspective view of an LED lighting fixture and passive cooling system in accordance with an embodiment or portion of an embodiment of the present invention. More specifically, FIG. 17 provides an LED 10 and passive cooling system 22 which was one of the exemplary subjects tested and reported on in the chart provided in FIG. 18. The specific LED lighting fixture 10 depicted in FIG. 17 comprises a 20 watt LED unit, contains 20 individual LEDs, the dimensions of the LED lighting fixture 10 are approximately twenty millimeter in length, with a circumference of approximately fifteen millimeters. The circumference of the LED lighting fixture 10 has a flattened portion, configured for mounting to the passive cooling system 22, that is approximately ten millimeters in width, and runs the length of the LED lighting fixture 10. The flattened portion of the LED lighting fixture 10 is mounted to a passive cooling system 22, comprising predominantly of aluminum in material. The dimensions of passive cooling system 22 are approximately one hundred millimeter (length), by one-hundred millimeter (width), by approximately 3.2 millimeters (height). The passive cooling system 22 has an approximate mass of 0.15 pounds.

FIG. 18 provides a chart containing the results of heat dissipation incorporating the LED lighting fixture depicted in FIG. 17 in accordance with an embodiment or portion of an embodiment of the present invention. Specifically, FIG. 1B provides data points for heat dissipation in relation to time (minutes) for five (5) variants of the present subject matter incorporating a passive cooling system 22 only. Column 1 provides data for a twenty watt LED with a load wattage of seventeen at 6.2 volts and 2.7 amperage. Column 2 provides data for the same LED as in Column 1, however the cooling system 22 is mounted to a conventional steel plate. The steel plate would be indicative of retrofitting the LED lighting fixture 10 to a conventional ceiling/wall fluorescent unit. Column 3 provides data for a fifteen watt LED with a load wattage of fourteen at 6.2 volts and 2,2 amperage. Column 4 provides data for the same LED as in Column 3, however the cooling system 22 is mounted to a conventional steel plate. As before the steel plate would be indicative of retrofitting the LED lighting fixture 10 to a conventional ceiling/wall fluorescent unit. Column 5 provides data for a fifteen watt LED with a load wattage of seven at 5.8 volts and 1.2 amperage, wherein the cooling system 22 is mounted to a conventional steel plate. The steel plate would be indicative of retrofitting the LED lighting fixture 10 to a conventional ceiling/wall fluorescent unit.

FIG. 19 provides a LED lighting fixture in accordance with an embodiment or portion of an embodiment of the present invention. Of particular interest in FIG. 19 is the active cooling system 24, which may be adapted to act the support or frame for the LED module 10. As depicted in FIG. 19, the LED module 10 is configured with at least one light emitting member 16, wherein the LED module 10 comprises a mounting frame 14 affixed to the core 12. The core 12 which provides support for the LED module 10, is configured to be at least partially convex in shape in at least one axis. The at least one light emitting member 16 is mounted to the core 12, and is in electronic communication with the mounting frame 14. The light emitting member 16 may comprise a circuit board for electronic communication with the mounting frame 14, or a circuit board may be integrated into the mounting frame 14, for electrical communication with the light emitting member 16.

As disclosed earlier, the LED module 10 comprises a cavity 20 situated in the core 12. The cavity 20 may project through the entire length of the LED module 10, or may only partially project into the core 12 of the LED module 10. As depicted in FIG. 19, the cavity 20 is centered along the circumference of the LED module 10, and extends the entire length of the LED module 10. The shape, width (w), height of the cavity 20 is constricted only by the size of the core 12, such that, the cavity 20 does not extend beyond the external width (w) and height (h) of the core 20.

In FIG. 19, the cavity 20 is at least partially occupied by the capillary tubing 42, which is a component of the active cooling system 24. The capillary tubing 42 is configured in the cavity 20 for active dissipation of heat from the LED modules 10 using a coolant. A complete disclosure of the active cooling system 24 and associated cooling elements are disclosed above, and are further incorporated by reference herein. FIG. 19 depicts one embodiment wherein the active cooling system 24 is configured to provide structural support to the LED modules 10, and simultaneously provide active cooling to the LED module 10. In various embodiments, the active cooling system 24 may be operational when a set temperature range is reached, and dormant if the temperature is outside said set temperature range.

In yet another embodiment, the capillary tubing 42 depicted in FIG. 19 may be substituted and/or partially replaced by solid tubing. Thus replacing the active cooling system 24, with a passive cooling system 22. As can be appreciated by some one of skill in the art, various combinations of active and passive cooling systems may be incorporated using hollow, partially hollow, and solid tubing for dissipation of heat from the LED modules 10.

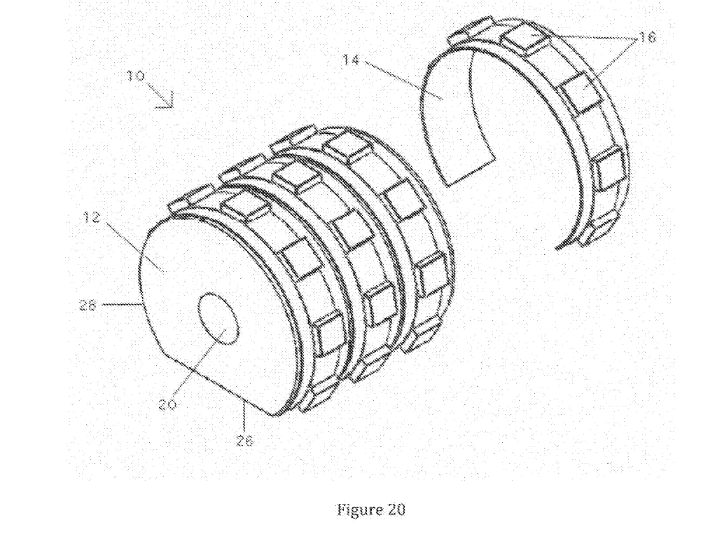

FIG. 20 provides a partially exploded perspective view of an LED lighting fixture in accordance with an embodiment or portion of an embodiment of the present invention. More specifically, FIG. 20 provides a partially exploded view of and embodiment of the LED module 10 provided as FIG. 1, wherein the LED module 10 is configured with at least one light emitting member 16 provided around a core 12, as well as a mounting frame 14 affixed to the core 12, wherein the mounting frame 14 has conductive properties for conducting electricity.

Obviously, numerous additional modifications and variations of the present invention are possible in light of the above teachings. It is therefore to be understood that within the scope of the appended claims, the present invention may be practiced otherwise than as specifically described herein.

What is claimed is:

1. A lighting fixture, comprising:
a plurality of discrete, light-emitting diode (LED) modules affixed to a heat-dissipating member, wherein each LED module comprises (a) a thermally conductive core having opposed first and second ends, a convex outer surface, a flat face, and a cavity extending into the core from the first and/or second end, (b) an electrically conductive mounting frame affixed to the convex outer surface of the core, and (c) a plurality of LEDs affixed to the mounting frame, and wherein the flat face of the core of each of the modules is affixed to the heat-dissipating member.

2. The lighting fixture of claim 1, wherein the mounting frame of each module can dissipate at least five-hundred joules of energy per minute.

3. The lighting fixture of claim 1, wherein the mounting frame of each module can dissipate at least two-hundred joules of energy per minute.

4. The lighting fixture of claim 1, wherein the core is comprised of an electrically non-conductive material.

5. The lighting fixture of claim 4, wherein the electrically non-conductive material is selected from the group consisting of ceramic, glass, plastics, plastic composites, resins, impregnated foam, combinations thereof, and derivatives thereof.

6. The lighting fixture of claim 1, wherein the mounting frame of each module comprises a heat conductive material.

7. The lighting fixture of claim 6, wherein the heat conductive material is selected from the group consisting of metals, alloys, carbon, plastic composites, metallic composites, combinations thereof, and derivatives thereof.

8. The lighting fixture of claim 1 wherein the cavity in the core of each module extends from the first end to the second end of the core.

9. The lighting fixture of claim 1, further comprising a coolant-based cooling system coupled to at least some of the LED modules, the coolant-based cooling system comprising a coolant a reservoir for housing at least a portion of the coolant, and tubing for housing at least a portion of the coolant, the tubing communicating with LED module core cavities.

10. The lighting fixture of claim 1, wherein the heat-dissipating member comprises an elongate piece of aluminum stock.

11. The fighting fixture of claim 1, wherein the LED modules are linearly arrayed along the heat-dissipating member.

12. The lighting fixture of claim 1, wherein the LED modules are spaced apart from each other.
